(19) United States
(12) Patent Application Publication
(10) Pub. No.: US 2025/0240374 A1
(43) Pub. Date: Jul. 24, 2025

(54) SHEET CONVEYING DEVICE CAPABLE OF DETERMINING WHETHER OR NOT SHEET HAS ANOMALOUS SHAPE, IMAGE FORMING APPARATUS, AND DETERMINATION METHOD

(71) Applicant: KYOCERA Document Solutions Inc., Osaka (JP)

(72) Inventor: Masaaki Nishihara, Osaka (JP)

(21) Appl. No.: 19/033,052

(22) Filed: Jan. 21, 2025

(30) Foreign Application Priority Data
Jan. 23, 2024 (JP) 2024-007895

(51) Int. Cl. H04N 1/00

(52) U.S. Cl. CPC H04N 1/00708; H04N 1/0057

(57) ABSTRACT

A sheet conveying device includes an image pickup portion, a count processing portion, and a determination processing portion. The image pickup portion includes a plurality of image pickup devices that are arranged so as to be aligned in a width direction orthogonal to a conveying direction of the sheet at a pass-through position through which a conveyed sheet passes, and outputs image pickup data indicating an image pickup result obtained by the plurality of image pickup devices at a predetermined image pickup cycle. The count processing portion counts, every time the image pickup data is output, the number of sheet pixels indicating the sheet, that are included in the image pickup data. The determination processing portion determines whether or not the sheet has an anomalous shape based on a transition of a count value obtained by the count processing portion.

### INCORPORATION BY REFERENCE

This application is based upon and claims the benefit of priority from the corresponding Japanese Patent Application No. 2024-007895 filed on Jan. 23, 2024, the entire contents of which are incorporated herein by reference.

### BACKGROUND

The present disclosure relates to a sheet conveying device, an image forming apparatus, and a determination method.

An image forming apparatus such as a printer includes a sheet conveying portion which conveys a sheet on which an image is to be formed. Further, there is known an image reading device which includes an image pickup portion that images the sheet conveyed by the sheet conveying portion, and determines whether or not the sheet has a missing portion based on image pickup data output from the image pickup portion. In this image reading device, an edge of the sheet included in the image pickup data is detected, and whether or not the sheet has a missing portion is determined based on the detected edge of the sheet.

### SUMMARY

A sheet conveying device according to an aspect of the present disclosure includes a sheet conveying portion, an image pickup portion, a count processing portion, and a determination processing portion. The sheet conveying portion conveys a sheet. The image pickup portion includes a plurality of image pickup devices that are arranged so as to be aligned in a width direction orthogonal to a conveying direction of the sheet at a pass-through position through which the sheet conveyed by the sheet conveying portion passes, and outputs image pickup data indicating an image pickup result obtained by the plurality of image pickup devices at a predetermined image pickup cycle. The count processing portion counts, every time the image pickup data is output by the image pickup portion, a number of sheet pixels indicating the sheet, that are included in the image pickup data. The determination processing portion determines whether or not the sheet has an anomalous shape based on a transition of a count value obtained by the count processing portion.

An image forming apparatus according to another aspect of the present disclosure includes the sheet conveying device and an image forming portion. The image forming portion forms an image on the sheet conveyed by the sheet conveying portion.

A determination method according to another aspect of the present disclosure is executed in a sheet conveying device including a sheet conveying portion which conveys a sheet, and an image pickup portion which includes a plurality of image pickup devices that are arranged so as to be aligned in a width direction orthogonal to a conveying direction of the sheet at a pass-through position through which the sheet conveyed by the sheet conveying portion passes, and outputs image pickup data indicating an image pickup result obtained by the plurality of image pickup devices at a predetermined image pickup cycle, and includes a count step and a determination step. The count step includes counting, every time the image pickup data is output by the image pickup portion, a number of sheet pixels indicating the sheet, that are included in the image pickup data. The determination step includes determining whether or not the sheet has an anomalous shape based on a transition of a count value obtained in the count step.

This Summary is provided to introduce a selection of concepts in a simplified form that are further described below in the Detailed Description with reference where appropriate to the accompanying drawings. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a cross-sectional view showing a configuration of an image forming apparatus according to an embodiment of the present disclosure;

FIG. 2 is a plan view showing configurations of an image forming portion and a conveying unit in the image forming apparatus according to the embodiment of the present disclosure;

FIG. 3 is a block diagram showing configurations of an image pickup portion, a shape determination portion, a control portion, and an operation display portion in the image forming apparatus according to the embodiment of the present disclosure;

FIG. 4 is a flowchart showing an example of shape determination processing executed in the image forming apparatus according to the embodiment of the present disclosure;

FIG. 5 is a diagram showing an example of a transition of a count value acquired in the image forming apparatus according to the embodiment of the present disclosure;

FIG. 6 is a diagram showing an example of the transition of the count value acquired in the image forming apparatus according to the embodiment of the present disclosure;

FIG. 7 is a diagram showing an example of the transition of the count value acquired in the image forming apparatus according to the embodiment of the present disclosure; and

FIG. 8 is a diagram showing an example of the transition of the count value acquired in the image forming apparatus according to the embodiment of the present disclosure.

### DETAILED DESCRIPTION

Hereinafter, an embodiment of the present disclosure will be described with reference to the attached drawings. It is noted that the following embodiment is an example of embodying the present disclosure and does not limit the technical scope of the present disclosure.

### Configuration of Image Forming Apparatus 100

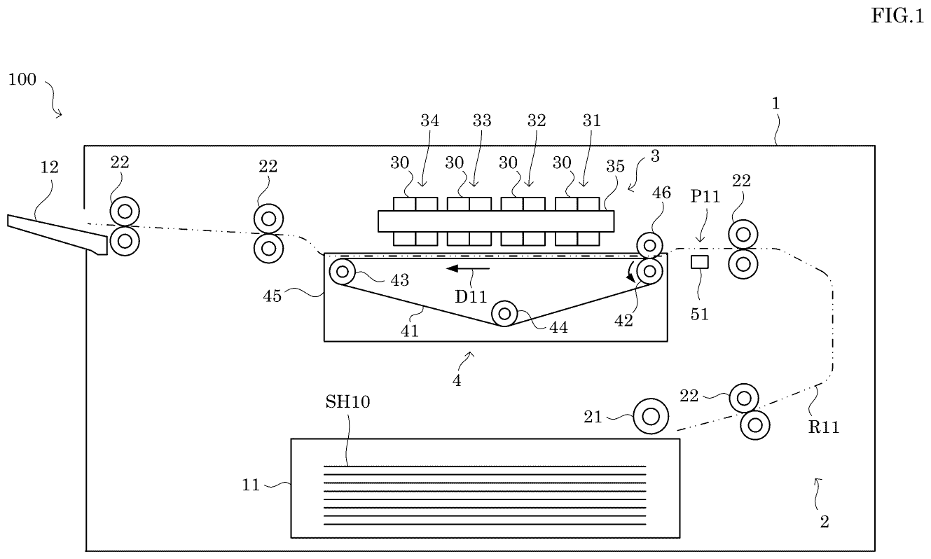

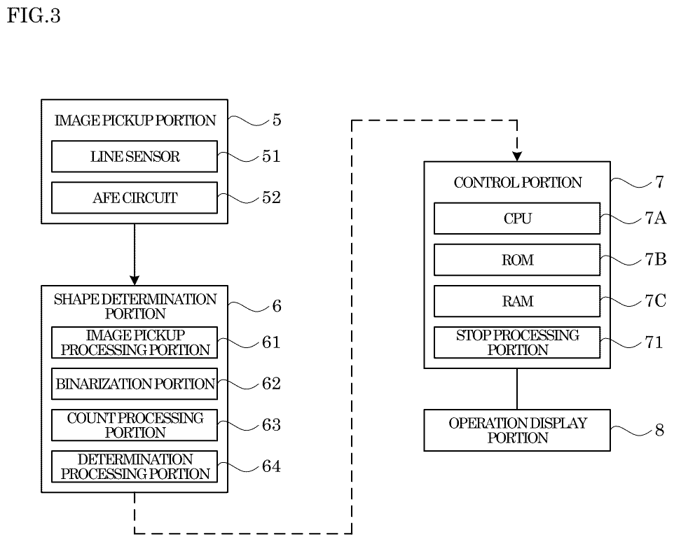

First, a configuration of an image forming apparatus 100 according to the embodiment of the present disclosure will be described with reference to FIG. 1 to FIG. 3. It is noted that in FIG. 1, a sheet conveying path R11 is indicated by a dash-dot-dot line. Further, in FIG. 3, a flow of image pickup data is indicated by a solid directional line. Furthermore, in FIG. 3, a flow of an electric signal is indicated by a broken directional line.

The image forming apparatus 100 is a printer that is capable of forming an image on a sheet SH10 (see FIG. 1) using an inkjet system. It is noted that the present disclosure may also be applied to a facsimile apparatus, a copying machine, or a multifunction peripheral that is capable of forming an image on the sheet SH10 using the inkjet system. Alternatively, the present disclosure may be applied to an image forming apparatus that is capable of forming an image on the sheet SH10 using a system different from the inkjet system such as an electrophotography.

As shown in FIG. 1, the image forming apparatus 100 includes a housing 1, a sheet conveying portion 2, an image forming portion 3, and a conveying unit 4. Further, the image forming apparatus 100 includes an image pickup portion 5, a shape determination portion 6, a control portion 7, and an operation display portion 8 shown in FIG. 3.

The housing 1 accommodates respective constituent elements of the image forming apparatus 100. A sheet feed cassette 11 (see FIG. 1) is detachably provided in the housing 1. The sheet feed cassette 11 stores the sheets SH10 on each of which an image is to be formed. A sheet discharge tray 12 (see FIG. 1) is provided on an outer side surface of the housing 1. The sheet SH10 on which an image has been formed by the image forming portion 3 is discharged onto the sheet discharge tray 12. Inside the housing 1, the sheet SH10 stored in the sheet feed cassette 11 is conveyed along the sheet conveying path R11 (see FIG. 1) that reaches the sheet discharge tray 12 via an image forming position of the image forming portion 3.

The sheet conveying portion 2 conveys the sheet SH10 stored in the sheet feed cassette 11 along the sheet conveying path R11 (see FIG. 1). As shown in FIG. 1, the sheet conveying portion 2 includes a pickup roller 21 and a plurality of conveying rollers 22. The pickup roller 21 takes out an uppermost sheet SH10 out of a batch of sheets stored in the sheet feed cassette 11, and feeds the sheet SH10 to the sheet conveying path R11. The plurality of conveying rollers 22 are provided so as to be aligned along the sheet conveying path R11. Each of the conveying rollers 22 conveys the sheet SH10 along the sheet conveying path R11. Each of the conveying rollers 22 conveys the sheet SH10 in a conveying direction D11 (see FIG. 1) that is directed from the sheet feed cassette 11 toward the sheet discharge tray 12.

The image forming portion 3 forms an image on the sheet SH10 conveyed by the sheet conveying portion 2. As shown in FIG. 1, the image forming portion 3 includes line heads 31 to 34 and a head frame 35.

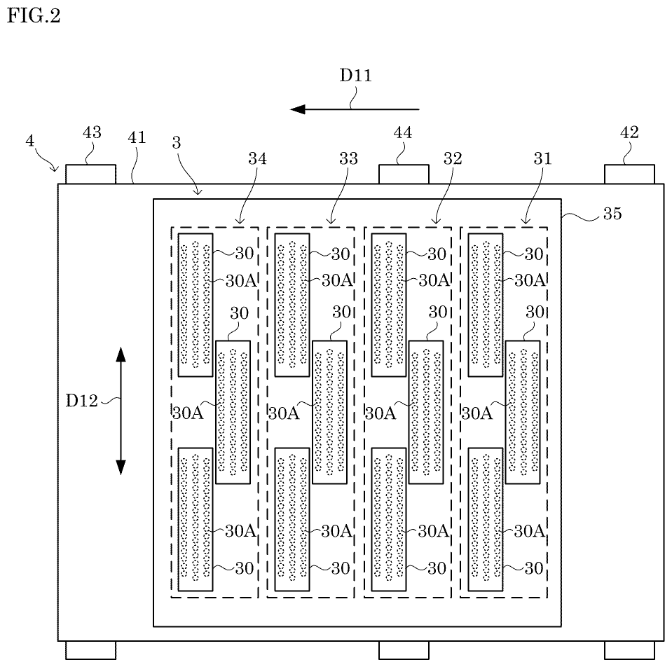

As shown in FIG. 2, each of the line heads 31 to 34 is elongated in a width direction D12 orthogonal to the conveying direction D11. Specifically, each of the line heads 31 to 34 has, in the width direction D12, a length corresponding to a width of a sheet SH10 of a maximum size out of the sheets SH10 that can be stored in the sheet feed cassette 11. The line heads 31 to 34 are provided so as to be aligned at regular intervals along the conveying direction D11.

As shown in FIG. 2, each of the line heads 31 to 34 includes a plurality of recording heads 30. Each of the recording heads 30 discharges ink toward the sheet SH10 conveyed by the conveying unit 4. Each of the recording heads 30 provided in the line head 31 discharges black ink. Each of the recording heads 30 provided in the line head 32 discharges cyan ink. Each of the recording heads 30 provided in the line head 33 discharges magenta ink. Each of the recording heads 30 provided in the line head 34 discharges yellow ink.

Each of the recording heads 30 includes a plurality of nozzles 30A (see FIG. 2) that discharge ink. Each of the nozzles 30A is provided on an opposing surface of the recording head 30 that opposes the sheet SH10 conveyed by the conveying unit 4.

Further, each of the recording heads 30 includes pressurization chambers (not shown), piezoelectric elements (not shown), and individual flow paths (not shown) that respectively correspond to the nozzles 30A. The pressurization chamber is in communication with the nozzle 30A and stores ink. The piezoelectric element causes the ink to be discharged from the nozzle 30A in accordance with an application of a predetermined driving voltage. The individual flow path is an ink flow path provided between the pressurization chamber and a common flow path (not shown) common to the plurality of nozzles 30A. The plurality of individual flow paths respectively corresponding to the plurality of nozzles 30A are connected to the common flow path. The common flow path is connected to an ink supplying portion (not shown) that supplies the ink to each of the pressurization chambers.

In the present embodiment, the line head 31 includes three recording heads 30 that are arranged in a staggered pattern along the width direction D12. Similar to the line head 31, each of the other line heads 32 to 34 also includes three recording heads 30 that are arranged in a staggered pattern along the width direction D12.

The head frame 35 supports the line heads 31 to 34. The head frame 35 is supported by the housing 1. It is noted that the number of line heads to be provided in the image forming portion 3 does not need to be four. Further, the number of recording heads 30 to be provided in each of the line heads 31 to 34 does not need to be three.

As shown in FIG. 1, the conveying unit 4 is arranged below the line heads 31 to 34. The conveying unit 4 conveys the sheet SH10 while causing the sheet SH10 to oppose the recording heads 30. For example, the conveying unit 4 conveys the sheet SH10 by a predetermined conveying amount every time the discharge of the ink is performed by the recording head 30. Further, while the discharge of the ink is performed by the recording head 30, the conveying unit 4 stops the conveyance of the sheet SH10. As shown in FIG. 1, the conveying unit 4 includes a conveying belt 41 on which the sheet SH10 is to be placed, a first tension roller 42, a second tension roller 43, and a third tension roller 44 across which the conveying belt 41 is stretched, and a conveying frame 45 that supports these. It is noted that a gap between the conveying belt 41 and the recording heads 30 is adjusted such that a gap between a surface of the sheet SH10 and the recording heads 30 during image formation becomes a predetermined distance (for example, 1 mm).

The first tension roller 42 is rotationally driven by a rotational driving force supplied from a motor (not shown). Thus, the conveying belt 41 rotates in a direction in which the sheet SH10 can be conveyed in the conveying direction D11 (see FIG. 1). It is noted that the conveying unit 4 is also provided with a suction unit (not shown) or the like that sucks in air via a large number of through-holes formed in the conveying belt 41 to cause the sheet SH10 to stick to the conveying belt 41. Further, a pressure roller 46 for conveying the sheet SH10 while pressing the sheet SH10 against the conveying belt 41 is provided above the first tension roller 42.

The image pickup portion 5 images the sheet SH10 conveyed by the sheet conveying portion 2 at an image pickup position P11 (see FIG. 1) that is more on an upstream side of the conveying direction D11 than the image forming portion 3 on the sheet conveying path R11.

As shown in FIG. 3, the image pickup portion 5 includes a line sensor 51 and an AFE (Analog Front End) circuit 52.

As shown in FIG. 1, the line sensor 51 is provided at the image pickup position P11 (an example of a pass-through position according to the present disclosure) (see FIG. 1) through which the sheet SH10 conveyed by the sheet conveying portion 2 passes. For example, the line sensor 51 is a CIS (Contact Image Sensor). The line sensor 51 includes a plurality of image pickup devices that are arranged so as to be aligned in the width direction D12 (see FIG. 2) orthogonal to the conveying direction D11 (see FIG. 1) of the sheet SH10. Each of the image pickup devices includes a light-emitting portion and a light-receiving portion. The light-emitting portion emits light toward the image pickup position P11. The light-receiving portion is provided to be capable of receiving the light that is emitted from the light-emitting portion and reflected by the sheet SH10 that passes through the image pickup position P11, and outputs analog electric signals corresponding to the received light amount.

The AFE circuit 52 is an electronic circuit which converts the analog electric signals output from each of the image pickup devices of the line sensor 51 into digital electric signals (image data). For example, the AFE circuit 52 converts the analog electric signals output from each of the image pickup devices into image data in which a pixel concentration is expressed in 256 gradations from 0 to 255.

The image pickup portion 5 outputs image pickup data indicating an image pickup result obtained by the line sensor 51 at a predetermined image pickup cycle. The image pickup cycle is set based on a conveying speed of the sheet SH10 by the sheet conveying portion 2.

The control portion 7 collectively controls the image forming apparatus 100. As shown in FIG. 3, the control portion 7 includes a CPU 7A, a ROM 7B, and a RAM 7C. The CPU 7A is a processor that executes various types of arithmetic processing. The ROM 7B is a nonvolatile storage device in which information such as control programs for causing the CPU 7A to execute various types of processing is stored in advance. The RAM 7C is a volatile or nonvolatile storage device that is used as a temporary storage memory (working area) for the various type of processing to be executed by the CPU 7A. The CPU 7A executes the various control programs stored in advance in the ROM 7B, to thus collectively control the image forming apparatus 100.

The operation display portion 8 includes a display portion such as a liquid crystal display that displays various types of information in response to control instructions from the control portion 7 and an operation portion such as an operation key or a touch panel that is used for inputting various types of information to the control portion 7 in accordance with user operations.

Incidentally, there is known an image reading device which determines whether or not the sheet SH10 has a missing portion based on the image pickup data output from the image pickup portion 5. In this image reading device, an edge of the sheet SH10 included in the image pickup data is detected, and whether or not the sheet SH10 has a missing portion is determined based on the detected edge of the sheet SH10.

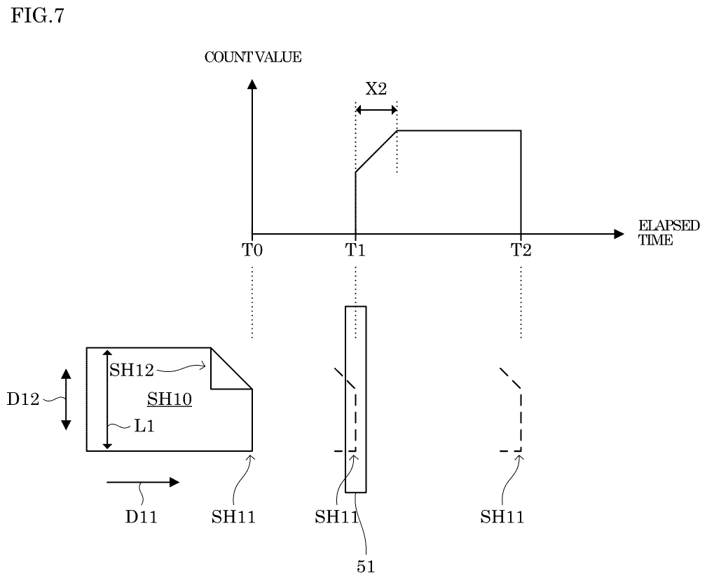

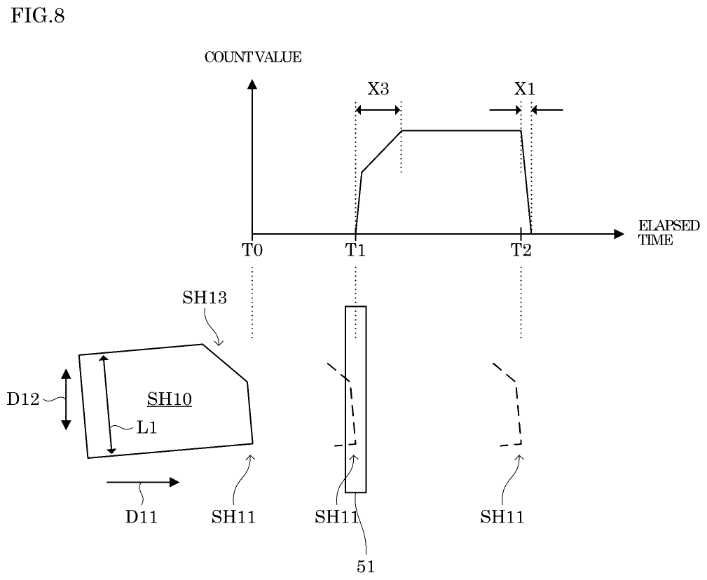

However, with the configuration of determining whether or not the sheet SH10 has a missing portion based on the detection result of the edge of the sheet SH10 included in the image pickup data, processing for determining whether or not the sheet SH10 has an anomalous shape becomes complex. The anomalous shape is an edge crease SH12 which is a crease at a corner portion of the sheet SH10 (see FIG. 7), a partial defect SH13 in which the sheet SH10 is partially chipped (see FIG. 8), or the like.

In contrast, the image forming apparatus 100 according to the embodiment of the present disclosure can determine whether or not the sheet SH10 has the anomalous shape by simple processing as will be described below.

The shape determination portion 6 determines whether or not the sheet SH10 has the anomalous shape based on the image pickup data output from the image pickup portion 5. The shape determination portion 6 is constituted of an electronic circuit such as an integrated circuit (ASIC, DSP). It is noted that the CPU 7A of the control portion 7 may execute the control program stored in the ROM 7B to thus function as the shape determination portion 6.

As shown in FIG. 3, the shape determination portion 6 includes an image pickup processing portion 61, a binarization portion 62, a count processing portion 63, and a determination processing portion 64. The device including the sheet conveying portion 2, the image pickup portion 5, the shape determination portion 6, and the control portion 7 is an example of a sheet conveying device according to the present disclosure.

The image pickup processing portion 61 causes the image pickup portion 5 to output the image pickup data at the image pickup cycle.

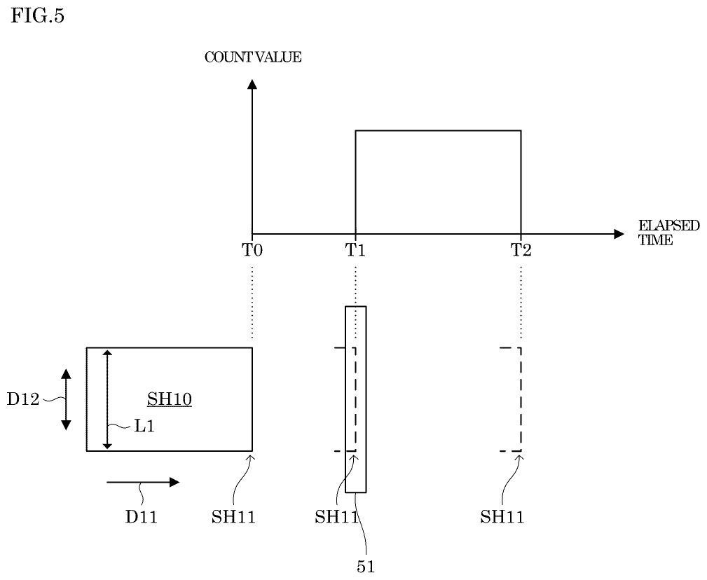

For example, when a tip end portion SH11 of the sheet SH10 (see FIG. 5) is detected by a sheet sensor (not shown) provided more on the upstream side of the conveying direction D11 than the image pickup position P11 on the sheet conveying path R11, the image pickup processing portion 61 causes the image pickup portion 5 to start outputting the image pickup data. Further, when a predetermined time has elapsed since detection of a rear end portion of the sheet SH10 by the sheet sensor, the image pickup processing portion 61 causes the image pickup portion 5 to end the output of the image pickup data.

The binarization portion 62 executes binarization processing for binarizing each pixel included in the image pickup data output from the image pickup portion 5 to a value indicating presence or absence of the sheet SH10. In the binarization processing, a pixel concentration value is converted into a first value that indicates presence of the sheet SH10 or a second value that indicates absence of the sheet SH10 based on whether or not the pixel concentration value exceeds a predetermined threshold value.

The count processing portion 63 counts the number of sheet pixels indicating the sheet SH10, that are included in the image pickup data, every time the image pickup data is output by the image pickup portion 5.

For example, the count processing portion 63 counts the number of sheet pixels included in the image pickup data obtained after the binarization processing is executed by the binarization portion 62.

The determination processing portion 64 determines whether or not the sheet SH10 has the anomalous shape based on a transition of a count value obtained by the count processing portion 63.

For example, the determination processing portion 64 determines that the sheet SH10 has the anomalous shape when a change time of the count value obtained by the count processing portion 63 exceeds a predetermined first time.

Herein, a relationship between a state of the sheet SH10 conveyed by the sheet conveying portion 2 and the transition of the count value obtained by the count processing portion 63 will be described with reference to FIG. 5 to FIG. 8.

FIG. 5 shows a transition of the count value obtained by the count processing portion 63 in a case where the sheet SH10 that does not have the anomalous shape and is not tilted with respect to the conveying direction D11 is conveyed.

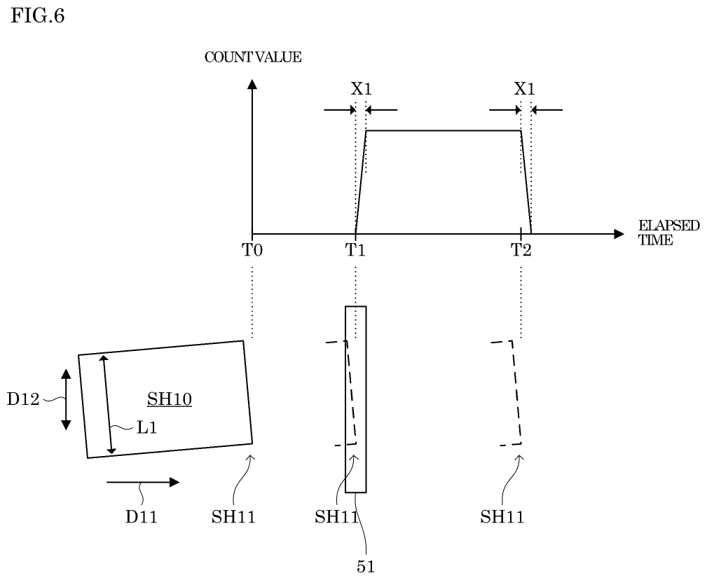

Further, FIG. 6 shows a transition of the count value obtained by the count processing portion 63 in a case where the sheet SH10 that does not have the anomalous shape and is tilted with respect to the conveying direction D11 is conveyed.

Furthermore, FIG. 7 shows a transition of the count value obtained by the count processing portion 63 in a case where the sheet SH10 that has the edge crease SH12 on the tip end portion SH11 side and is not tilted with respect to the conveying direction D11 is conveyed.

Furthermore, FIG. 8 shows a transition of the count value obtained by the count processing portion 63 in a case where the sheet SH10 that has the partial defect SH13 on the tip end portion SH11 side and is tilted with respect to the conveying direction D11 is conveyed.

It is noted that a timing T0 shown in FIG. 5 to FIG. 8 is a timing at which the tip end portion SH11 of the sheet SH10 has been detected by the sheet sensor. Moreover, a timing T1 shown in FIG. 5 to FIG. 8 is a timing at which the tip end portion SH11 of the sheet SH10 has reached the image pickup position P11. Further, a timing T2 shown in FIG. 5 to FIG. 8 is a timing at which a conveying distance of the sheet SH10 from the timing T1 has reached a length of the sheet SH10 in the conveying direction D11. Furthermore, in FIG. 5 to FIG. 8, the tip end portion SH11 of the sheet SH10 at each of the timing T1 and the timing T2 is indicated by broken lines.

As shown in FIG. 5, when the sheet SH10 does not have the anomalous shape and is not tilted with respect to the conveying direction D11, the count value obtained by the count processing portion 63 rises from zero to a value corresponding to a length L1 (see FIG. 5) of the sheet SH10 in the width direction D12 instantly at the timing T1. In addition, the count value falls from the value corresponding to the length L1 to zero instantly at the timing T2.

As shown in FIG. 6, when the sheet SH10 does not have the anomalous shape and is tilted with respect to the conveying direction D11, the count value obtained by the count processing portion 63 rises from zero to the value corresponding to the length L1 (see FIG. 6) before a change time X1 (see FIG. 6) elapses from the timing T1. In addition, the count value falls from the value corresponding to the length L1 to zero before the change time X1 elapses from the timing T2. The change time X1 becomes longer as a tilt angle of the sheet SH10 with respect to the conveying direction D11 becomes larger.

As shown in FIG. 7, when the sheet SH10 has the edge crease SH12 on the tip end portion SH11 side and is not tilted with respect to the conveying direction D11, the count value obtained by the count processing portion 63 rises from zero to the value corresponding to the length L1 (see FIG. 7) before a change time X2 (see FIG. 7) elapses from the timing T1. In addition, the count value falls from the value corresponding to the length L1 to zero instantly at the timing T2. The change time X2 becomes longer as a size of the edge crease SH12 in the conveying direction D11 becomes larger.

As shown in FIG. 8, when the sheet SH10 has the partial defect SH13 on the tip end portion SH11 side and is tilted with respect to the conveying direction D11, the count value obtained by the count processing portion 63 rises from zero to the value corresponding to the length L1 (see FIG. 8) before a change time X3 (see FIG. 8) elapses from the timing T1. In addition, the count value falls from the value corresponding to the length L1 to zero before the change time X1 (see FIG. 8) elapses from the timing T2. The change time X3 becomes longer as a size of the partial defect SH13 in the conveying direction D11 becomes larger.

As is apparent from FIG. 5 to FIG. 8, when the sheet SH10 has the anomalous shape on the tip end portion SH11 side, a change time of the count value obtained by the count processing portion 63 from zero to the value corresponding to the length L1 (see FIG. 5 to FIG. 8) becomes long. Further, when the sheet SH10 has the anomalous shape on the rear end portion side, the change time of the count value obtained by the count processing portion 63 from the value corresponding to the length L1 (see FIG. 5 to FIG. 8) to zero becomes long. Therefore, it is possible to determine that the sheet SH10 has the anomalous shape when the change time of the count value obtained by the count processing portion 63 exceeds the first time. In addition, the anomalous shape which is small to some extent can be disregarded by adjusting the first time.

Herein, the determination processing portion 64 determines whether or not the sheet SH10 has the anomalous shape based on the transition of the count value obtained by the count processing portion 63 up to a time when a second time corresponding to the size of the sheet SH10 in the conveying direction D11 elapses since the time of detection of the tip end portion SH11 of the sheet SH10 in the conveying direction D11, that is based on the image pickup data. Thus, it is possible to avoid a situation where, when the sheet SH10 is a tabbed sheet that includes a tab protruding from a rear end portion thereof, the tabbed portion is erroneously determined as the anomalous shape.

For example, the determination processing portion 64 acquires the second time using table data indicating a correspondence relationship between the size of the sheet SH10 and the second time. The table data only needs to be stored in advance in a nonvolatile storage device (not shown) provided in the shape determination portion 6. Moreover, the size of the sheet SH10 only needs to be set in advance by the user.

It is noted that the determination processing portion 64 may determine that the sheet SH10 has the anomalous shape when a change speed of the count value changes during the change of the count value obtained by the count processing portion 63 (see FIG. 7 and FIG. 8).

Meanwhile, as shown in FIG. 3, the control portion 7 includes a stop processing portion 71. Specifically, the control portion 7 uses the CPU 7A to execute the control program stored in the ROM 7B. Thus, the control portion 7 functions as the stop processing portion 71.

The stop processing portion 71 causes the sheet conveying portion 2 to stop the conveyance of the sheet SH10 when it is determined by the determination processing portion 64 that the sheet SH10 has the anomalous shape. Thus, it is possible to avoid a collision between the edge crease SH12 of the sheet SH10 and the constituent element of the image forming apparatus 100 like the recording heads 30.

For example, the stop processing portion 71 causes, as well as cause the sheet conveying portion 2 to stop the conveyance of the sheet SH10, the operation display portion 8 to display a message notifying that the sheet SH10 has been determined as having the anomalous shape.

### Shape Determination Processing

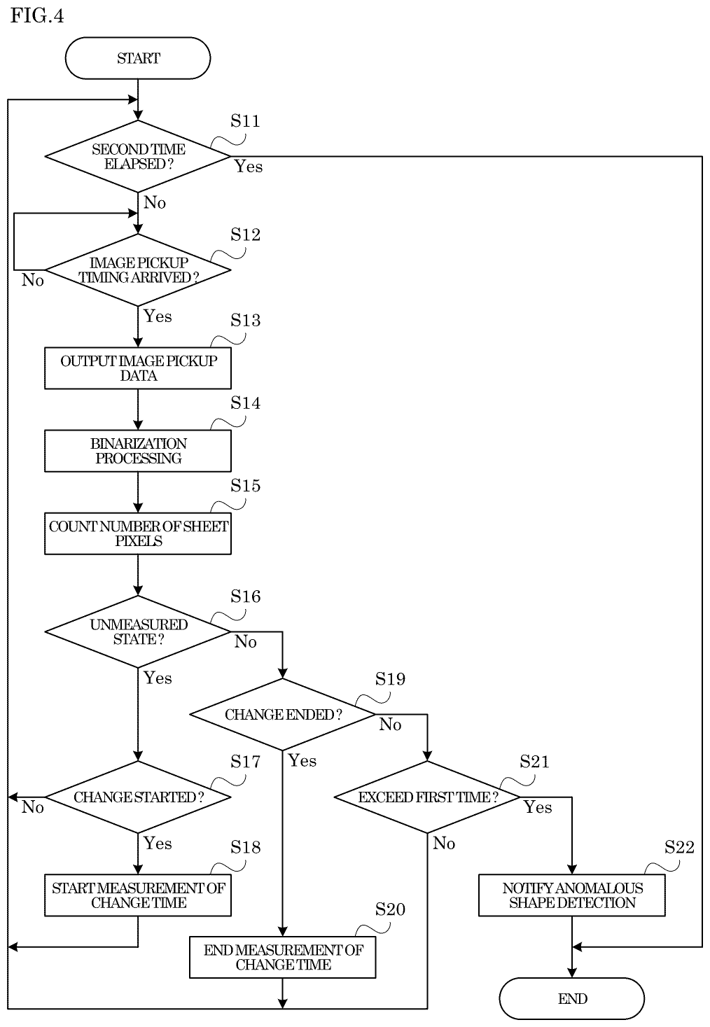

Hereinafter, with reference to FIG. 4, a determination method according to the present disclosure will be described along with exemplary procedures of shape determination processing executed by the shape determination portion 6 in the image forming apparatus 100. Herein, Step S11, Step S12, . . . represent numbers of processing procedures (steps) executed by the shape determination portion 6. It is noted that the shape determination processing is executed when the tip end portion SH11 of the sheet SH10 is detected by the sheet sensor.

### <Step S11>

First, in Step S11, the shape determination portion 6 determines whether or not the second time has elapsed since the detection of the tip end portion SH11 of the sheet SH10 in the conveying direction D11, that is based on the image pickup data.

Specifically, the shape determination portion 6 determines that the second time has elapsed since the detection of the tip end portion SH11 when the second time has elapsed since the timing at which it is first determined that a change of the count value has started in processing of Step S17 to be described later.

Herein, when determining that the second time has elapsed since the detection of the tip end portion SH11 (Yes in S11), the shape determination portion 6 ends the shape determination processing. On the other hand, when determining that the second time has not elapsed since the detection of the tip end portion SH11 (No in S11), the shape determination portion 6 shifts the processing to Step S12.

### <Step S12>

In Step S12, the shape determination portion 6 determines whether or not an image pickup timing of the sheet SH10 has arrived.

Specifically, when the number of times of execution of the processing of Step S12 is one, the shape determination portion 6 readily determines that the image pickup timing has arrived. Further, when the number of times of execution of the processing of Step S12 is two or more, the shape determination portion 6 determines that the image pickup timing has arrived when a time corresponding to the image pickup cycle has elapsed since the arrival of the last image pickup timing.

Herein, when determining that the image pickup timing has arrived (Yes in S12), the shape determination portion 6 shifts the processing to Step S13. On the other hand, when determining that the image pickup timing has not arrived (No in S12), the shape determination portion 6 waits for the arrival of the image pickup timing in Step S12.

### <Step S13>

In Step S13, the shape determination portion 6 causes the image pickup portion 5 to output the image pickup data. The processing of Step S13 is executed by the image pickup processing portion 61 of the shape determination portion 6.

### <Step S14>

In Step S14, the shape determination portion 6 executes the binarization processing on the image pickup data output in Step S13. The processing of Step S14 is executed by the binarization portion 62 of the shape determination portion 6.

### <Step S15>

In Step S15, the shape determination portion 6 counts the number of sheet pixels included in the image pickup data obtained after the execution of the binarization processing. The processing of Step S15 is an example of a count step according to the present disclosure and is executed by the count processing portion 63 of the shape determination portion 6.

### <Step S16>

In Step S16, the shape determination portion 6 determines whether or not it is an unmeasured state where the change time of the count value counted by the processing of Step S15 is not measured.

Herein, when determining that it is the unmeasured state (Yes in S16), the shape determination portion 6 shifts the processing to Step S17. On the other hand, when determined that it is not the unmeasured state (No in S16), the shape determination portion 6 shifts the processing to Step S19.

### <Step S17>

In Step S17, the shape determination portion 6 determines whether or not a change of the count value counted by the processing of Step S15 has started.

Specifically, the shape determination portion 6 determines that the change of the count value has started when a difference between two count values that have been acquired last exceeds a predetermined reference value. The reference value is set based on a variation amount of the count value up to a time when the tip end portion SH11 of the sheet SH10 reaches the image pickup position P11.

Herein, when determining that the change of the count value has started (Yes in S17), the shape determination portion 6 shifts the processing to Step S18. On the other hand, when determining that the change of the count value has not started (No in S17), the shape determination portion 6 shifts the processing to Step S11.

### <Step S18>

In Step S18, the shape determination portion 6 starts the measurement of the change time of the count value.

### <Step S19>

In Step S19, the shape determination portion 6 determines whether or not the change of the count value counted by the processing of Step S15 has ended.

Specifically, the shape determination portion 6 determines that the change of the count value has ended when a difference between two count values that have been acquired last is equal to or smaller than the reference value.

Herein, when determining that the change of the count value has ended (Yes in S19), the shape determination portion 6 shifts the processing to Step S20. On the other hand, when determining that the change of the count value has not ended (No in S19), the shape determination portion 6 shifts the processing to Step S21.

### <Step S20>

In Step S20, the shape determination portion 6 ends the measurement of the change time of the count value.

### <Step S21>

In Step S21, the shape determination portion 6 determines whether or not the change time of the count value that is being measured exceeds the first time. The processing of Step S21 is an example of a determination step according to the present disclosure and is executed by the determination processing portion 64 of the shape determination portion 6.

Herein, when determining that the change time of the count value that is being measured will exceed the first time (Yes in S21), the shape determination portion 6 shifts the processing to Step S22. On the other hand, when determining that the change time of the count value that is being measured will not exceed the first time (No in S21), the shape determination portion 6 shifts the processing to Step S11.

### <Step S22>

In Step S22, the shape determination portion 6 notifies the control portion 7 that the anomalous shape has been detected from the sheet SH10 being conveyed.

In this manner, in the image forming apparatus 100, the number of sheet pixels included in the image pickup data is counted every time the image pickup data is output by the image pickup portion 5. Then, whether or not the sheet SH10 has the anomalous shape is determined based on the transition of the count value of the sheet pixels. Thus, it is possible to determine whether or not the sheet SH10 has an anomalous shape by simple processing.

### Notes of Disclosure

Hereinafter, a general outline of the disclosure extracted from the embodiment described above will be noted. It is noted that the respective configurations and processing functions described in the notes below can be sorted and arbitrarily combined as appropriate.

### <Note 1>

A sheet conveying device, including: a sheet conveying portion which conveys a sheet; an image pickup portion which includes a plurality of image pickup devices that are arranged so as to be aligned in a width direction orthogonal to a conveying direction of the sheet at a pass-through position through which the sheet conveyed by the sheet conveying portion passes, and outputs image pickup data indicating an image pickup result obtained by the plurality of image pickup devices at a predetermined image pickup cycle; a count processing portion which counts, every time the image pickup data is output by the image pickup portion, a number of sheet pixels indicating the sheet, that are included in the image pickup data; and a determination processing portion which determines whether or not the sheet has an anomalous shape based on a transition of a count value obtained by the count processing portion.

### <Note 2>

The sheet conveying device according to note 1, in which the determination processing portion determines that the sheet has the anomalous shape when a change time of the count value exceeds a predetermined first time.

### <Note 3>

The sheet conveying device according to note 1, in which the determination processing portion determines that the sheet has the anomalous shape when a change speed of the count value changes during a change of the count value.

### <Note 4>

The sheet conveying device according to any one of notes 1 to 3, in which the determination processing portion determines whether or not the sheet has the anomalous shape based on the transition of the count value up to a time when a second time corresponding to a size of the sheet elapses since a time of detection of a tip end portion of the sheet in the conveying direction, that is based on the image pickup data.

### <Note 5>

The sheet conveying device according to any one of notes 1 to 4, including: a stop processing portion which stops the conveyance of the sheet by the sheet conveying portion when it is determined by the determination processing portion that the sheet has the anomalous shape.

### <Note 6>

An image forming apparatus, including: the sheet conveying device according to any one of notes 1 to 5; and an image forming portion which forms an image on the sheet conveyed by the sheet conveying portion.

### <Note 7>

A determination method executed in a sheet conveying device including a sheet conveying portion which conveys a sheet, and an image pickup portion which includes a plurality of image pickup devices that are arranged so as to be aligned in a width direction orthogonal to a conveying direction of the sheet at a pass-through position through which the sheet conveyed by the sheet conveying portion passes, and outputs image pickup data indicating an image pickup result obtained by the plurality of image pickup devices at a predetermined image pickup cycle, the determination method including: a count step of counting, every time the image pickup data is output by the image pickup portion, a number of sheet pixels indicating the sheet, that are included in the image pickup data; and a determination step of determining whether or not the sheet has an anomalous shape based on a transition of a count value obtained in the count step.

It is to be understood that the embodiments herein are illustrative and not restrictive, since the scope of the disclosure is defined by the appended claims rather than by the description preceding them, and all changes that fall within metes and bounds of the claims, or equivalence of such metes and bounds thereof are therefore intended to be embraced by the claims.

1. A sheet conveying device, comprising:
a sheet conveying portion which conveys a sheet;
an image pickup portion which includes a plurality of image pickup devices that are arranged so as to be aligned in a width direction orthogonal to a conveying direction of the sheet at a pass-through position through which the sheet conveyed by the sheet conveying portion passes, and outputs image pickup data indicating an image pickup result obtained by the plurality of image pickup devices at a predetermined image pickup cycle;
a count processing portion which counts, every time the image pickup data is output by the image pickup portion, a number of sheet pixels indicating the sheet, that are included in the image pickup data; and
a determination processing portion which determines whether or not the sheet has an anomalous shape based on a transition of a count value obtained by the count processing portion.

2. The sheet conveying device according to claim 1, wherein
the determination processing portion determines that the sheet has the anomalous shape when a change time of the count value exceeds a predetermined first time.

3. The sheet conveying device according to claim 1, wherein
the determination processing portion determines that the sheet has the anomalous shape when a change speed of the count value changes during a change of the count value.

4. The sheet conveying device according to claim 1, wherein
the determination processing portion determines whether or not the sheet has the anomalous shape based on the transition of the count value up to a time when a second time corresponding to a size of the sheet elapses since a time of detection of a tip end portion of the sheet in the conveying direction, that is based on the image pickup data.

5. The sheet conveying device according to claim 1, comprising:
a stop processing portion which stops the conveyance of the sheet by the sheet conveying portion when it is determined by the determination processing portion that the sheet has the anomalous shape.

6. An image forming apparatus, comprising:
the sheet conveying device according to claim 1; and
an image forming portion which forms an image on the sheet conveyed by the sheet conveying portion.

7. A determination method executed in a sheet conveying device including a sheet conveying portion which conveys a sheet, and an image pickup portion which includes a plurality of image pickup devices that are arranged so as to be aligned in a width direction orthogonal to a conveying direction of the sheet at a pass-through position through which the sheet conveyed by the sheet conveying portion passes, and outputs image pickup data indicating an image pickup result obtained by the plurality of image pickup devices at a predetermined image pickup cycle, the determination method comprising:
a count step of counting, every time the image pickup data is output by the image pickup portion, a number of sheet pixels indicating the sheet, that are included in the image pickup data; and
a determination step of determining whether or not the sheet has an anomalous shape based on a transition of a count value obtained in the count step.
